(19) United States
(12) Patent Application Publication
(10) Pub. No.: US 2006/0138817 A1
(43) Pub. Date: Jun. 29, 2006

(54) Energy absorbing seat recliner assembly

(76) Inventors: Patrick J. Gorman, White Lake, MI (US); Cheryl L. Warsinske, Port Huron, MI (US); Christopher L. VanHoeck, Allenton, MI (US); Bernardus W. G. van de Geer, Nol (SE); Erik O. Pettersson, Bankeryd (SE)

Correspondence Address: HARNESS, DICKEY & PIERCE, P.L.C., P.O. BOX 828, BLOOMFIELD HILLS, MI, 48303, US

(21) Appl. No.: 11/316,207

(22) Filed: Dec. 22, 2005

Related U.S. Application Data
(60) Provisional application No. 60/640,145, filed on Dec. 29, 2004.
(60) Provisional application No. 60/654,721, filed on Feb. 21, 2005.

(51) Int. Cl. B60N 2/427

(52) U.S. Cl. 297/216.15

(57) ABSTRACT

An energy absorption system for a seat assembly includes a first housing plate and a second housing plate defining coaxial elongate apertures having a first end and a second end. A torsion bar is fixed for movement with the seatback and is slidably received within the elongate apertures and a biasing member is supported by one of the housing plates and imparts a biasing force on the torsion bar to bias the torsion bar toward the first ends of the elongate apertures. When a force is applied to the torsion bar, the torsion bar moves toward the second end of the apertures and against the biasing force to absorb energy associated with the force. When the torsion bar reaches the second end of the apertures, the torsion bar may yield to further absorb energy.

### CROSS-REFERENCE TO RELATED APPLICATIONS

This application claims the benefit of U.S. Provisional Application No. 60/640,145, filed on Dec. 29, 2004, and U.S. Provisional Application No. 60/654,721, filed on Feb. 21, 2005. The disclosures of the above applications are incorporated herein by reference.

### FIELD

The present teachings relate to seat assemblies, and more particularly, to a seat assembly having an energy absorption system.

### BACKGROUND

When a moving vehicle is abruptly stopped (i.e., from contact with a stationary object or another vehicle), the forward momentum and associated forces are transferred to vehicle occupants. To minimize the effects of such forces, vehicle safety systems transfer energy generated by the vehicle impact to the structure of the vehicle and away from the vehicle occupants.

Modern vehicle safety systems commonly include a variety of energy management devices such as seatbelts and airbags to help protect a passenger in the event of an impact or accident. Such systems are typically designed to work together with sensors and other structural elements such as door beams, side sill sections, and body panels to improve vehicle safety by gradually decelerating the occupants with the vehicle structure to dissipate the forces away from the occupants and into the vehicle structure.

Impact forces are commonly absorbed by the vehicle structure through deformation of steel and other structural components. Forces associated with an occupant moving relative to the vehicle are safely and controllably transmitted to the vehicle structure via the seatbelt or airbag such that the structure, as opposed to the occupant, can manage the energy.

Energy management devices are commonly designed for use in conjunction with one another to transfer impact forces to the associated vehicle structure. For example, airbags transmit a force received by a moving occupant to the vehicle structure via a steering column or cross-car beam, while seatbelts transmit similar forces to the vehicle structure via a vehicle floor pan and/or vehicle seat. Such vehicle seats receive the impact force from one, or both of, the airbag and seatbelt to dissipate energy safely to the vehicle structure, thereby protecting the vehicle occupants. Thus, interaction between the occupant and the seatback plays a role in energy management during an impact event.

### SUMMARY

An energy absorption system for a seat assembly includes a seatback rotatably supported by a seat bottom. The energy absorption system includes a first housing plate and a second housing plate. The first and second housing plates each include an elongate aperture formed therein defining a first end and a second end. The elongate apertures are coaxially aligned such that the respective ends of the first housing plate are aligned with respective ends of the second housing plate. A torsion bar is fixed for movement with the seatback and is slidably received within the elongate apertures of the first housing plate and second housing plate. A biasing member is supported by one of the housing plates and imparts a biasing force on the torsion bar to thereby bias the torsion bar toward the first ends of the elongate apertures.

The torsion bar overcomes the biasing member when a first predetermined force is applied to the seatback. As the torsion bar overcomes the biasing member, it moves from the first ends of the elongate apertures to the second ends of the elongate apertures of the housing plates. When the torsion bar is located at the second ends of the elongate apertures and a second predetermined force is applied to the seatback, the torsion bar yields. When the torsion bar yields, energy associated with movement of the seatback relative to the seat bottom is absorbed.

In one configuration, the energy adsorption system may alternatively include a seatback configured to move linearly along a first axis when a first predetermined force is applied thereto, and rotationally when a second predetermined force is applied thereto to absorb energy associated with movement of the seatback relative to a seat bottom.

In another configuration, the energy absorption system may alternatively include a guide plate, a link, and a torsion bar. The torsion bar is fixedly attached to the link at a first end and fixedly attached to one of vehicle structure and the seat bottom at a second end. The torsion bar yields when a predetermined force is applied to the seatback due to rotation of the link and absorbs energy associated with movement of a seatback relative to a seat bottom.

Further areas of applicability will become apparent from the detailed description provided hereinafter. It should be understood that the detailed description is intended for purposes of illustration and is not intended to limit the scope of the teachings.

### BRIEF DESCRIPTION OF THE DRAWINGS

FIG. 1 is a perspective view of a an energy absorption system, shown from a first side;

FIG. 2 is a perspective view of the energy absorption system of FIG. 1 shown from a second side;

FIG. 3 is an exploded view of the energy absorption system of FIG. 1;

FIG. 4 is a side view of the energy absorption system of FIG. 1 in a forward position;

FIG. 5 is a side view of the energy absorption system of FIG. 1 in a first rearward position;

FIG. 6 is a side view of the energy absorption system of FIG. 1 in a second rearward position;

FIG. 7 is a side view of a seat assembly incorporating the energy absorption system of FIG. 1 in a forward position;

FIG. 8 is a side view of a seat assembly incorporating the energy absorption system of FIG. 1 in a first rearward position;

FIG. 9 is a side view of a seat assembly incorporating the energy absorption system of FIG. 1 in a second rearward position;

FIG. 10 is a perspective view of another energy absorption system in a forward position;

FIG. 11 is an exploded view of the energy absorption system of FIG. 10;

FIG. 12 is a side view of the energy absorption system of FIG. 10 in a forward position;

FIG. 13 is a side view of the energy absorption system of FIG. 10 in a rearward position;

FIG. 14 is a side view of a seat assembly incorporating the energy absorption system of FIG. 10 in a forward position; and

FIG. 15 is a side view of a seat assembly incorporating the energy absorption system of FIG. 10 in a rearward position.

### DETAILED DESCRIPTION

The following description is merely exemplary in nature and is in no way intended to limit the teachings, its application, or uses.

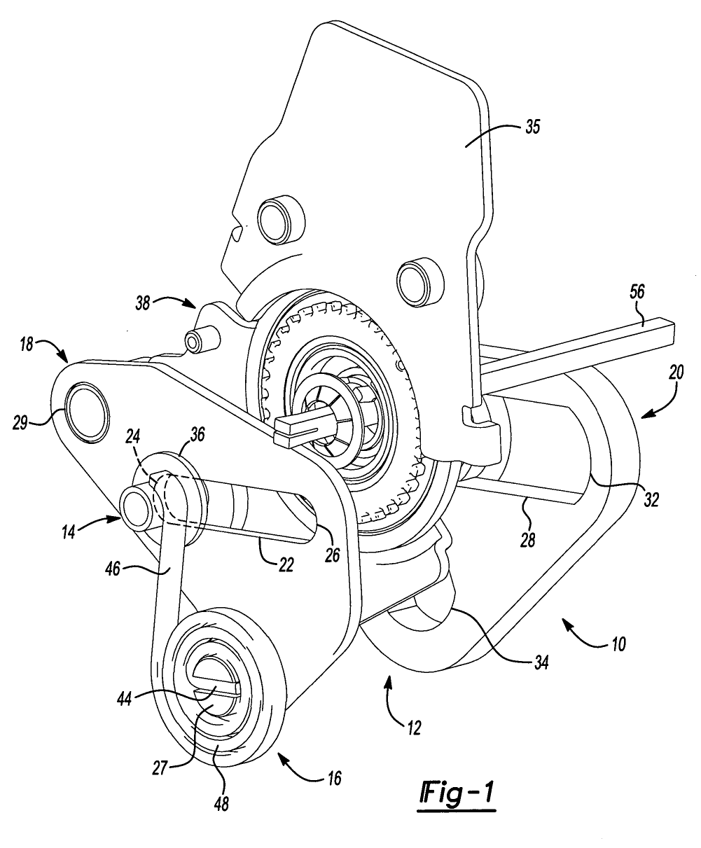

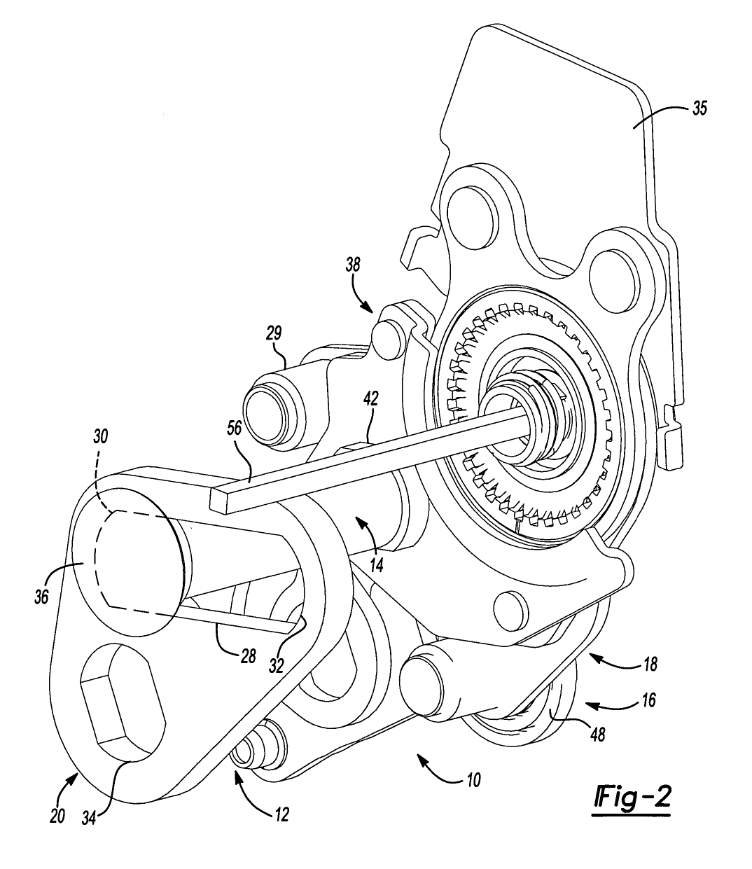

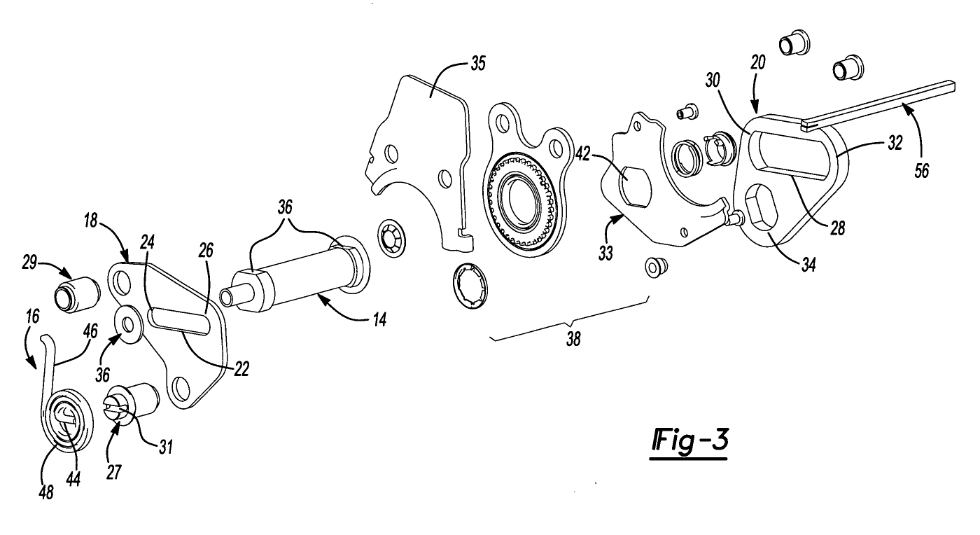

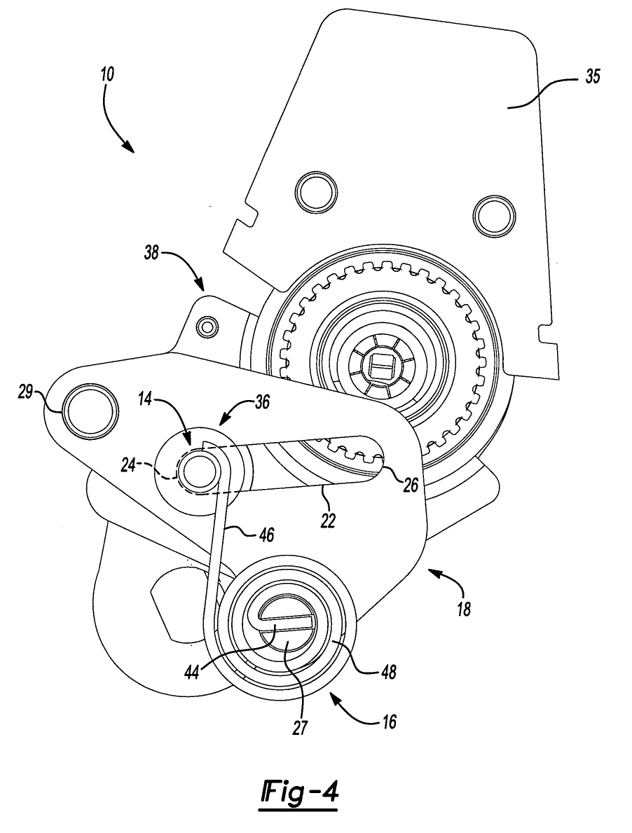

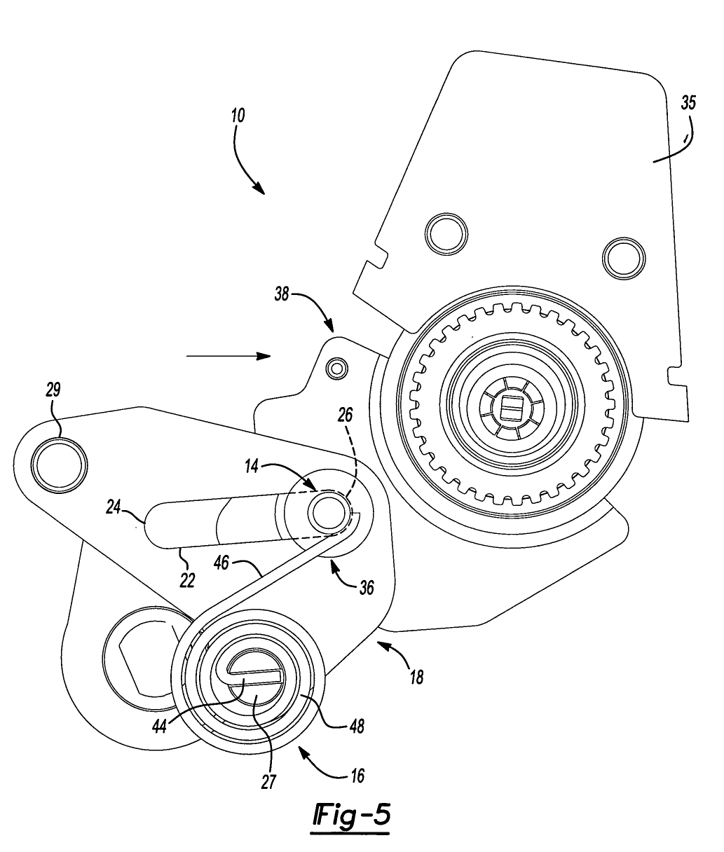

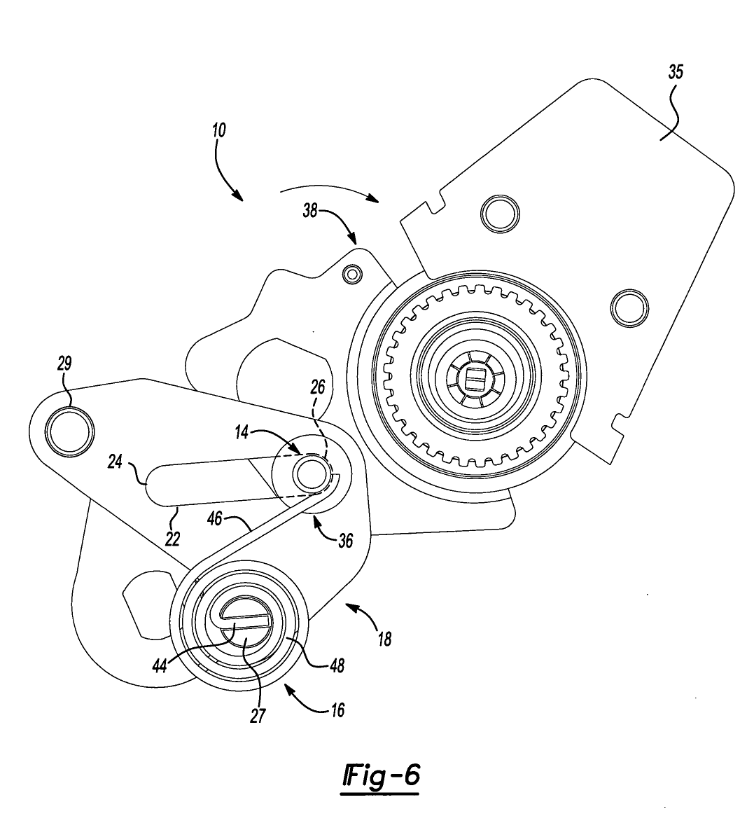

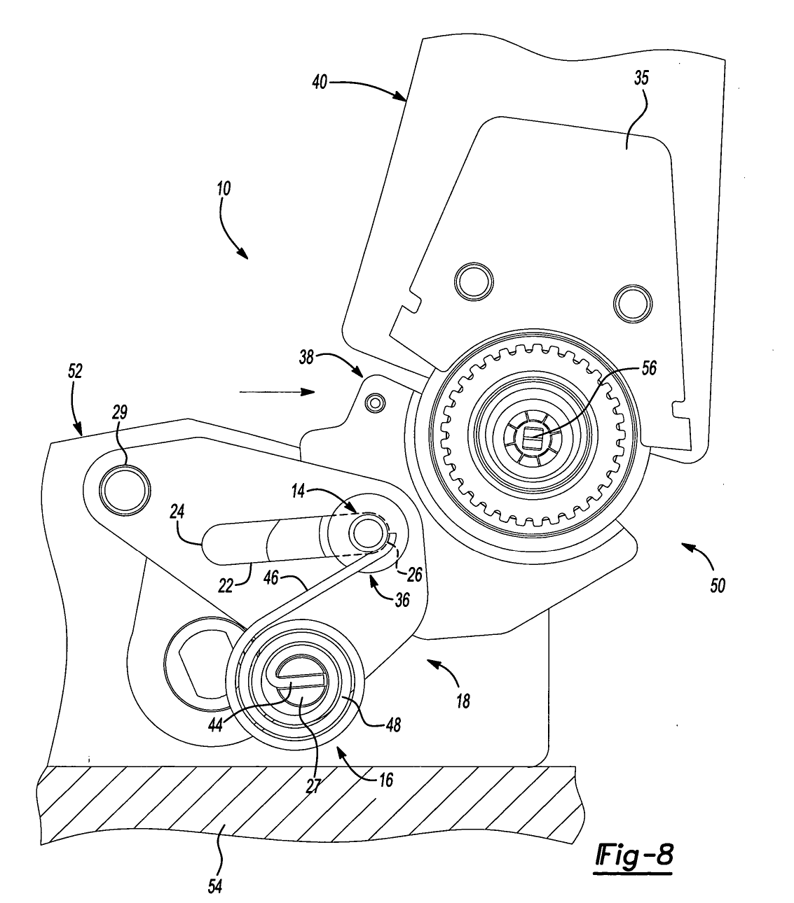

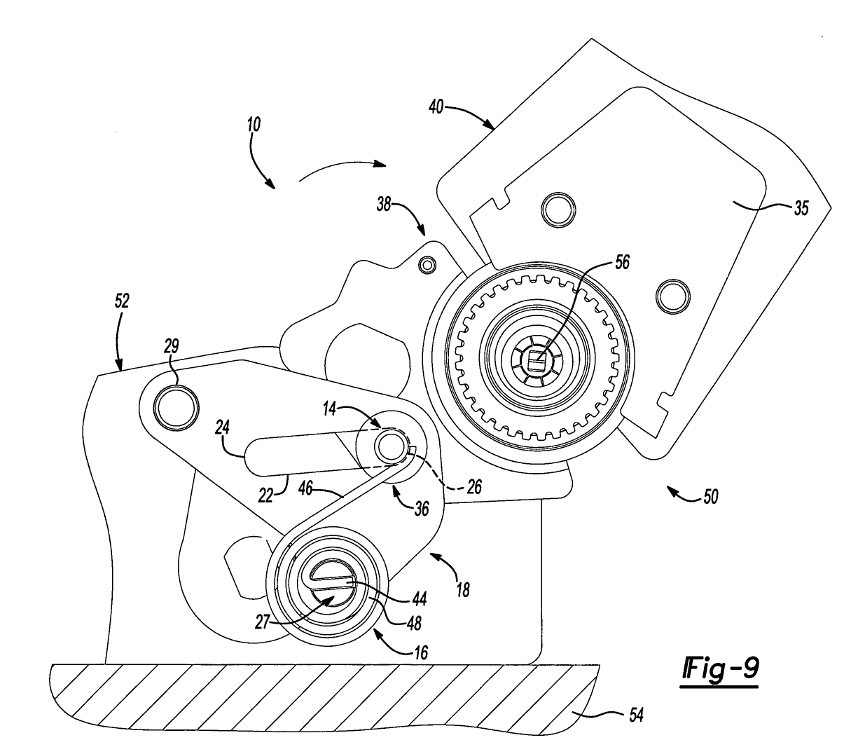

With reference to FIGS. 1-9, an energy absorption system 10 is provided and includes a housing 12, a torsion bar 14, and a biasing member shown as a coil spring 16. The housing 12 slidably supports the torsion bar 14 between a forward position and a rearward position while the coil spring 16 biases the torsion bar 14 to restrict movement of the torsion bar 14 from the forward position to the rearward position. In so doing, the coil spring 16 absorbs energy associated with movement of the torsion bar 14 from the forward position to the rearward position.

The housing 12 includes a first housing plate 18 and a second housing plate 20. The housing plates 18, 20 could be, for example, a whip plate and a guide plate. The first housing plate 18 includes an elongate aperture 22, such as a slot, having a first end 24 and a second end 26. The first housing plate 18 also includes a spring post 27 fixedly attached thereto and an attachment post 29. The spring post 27 includes a spring slot 31 that receives the coil spring 16 while the attachment post 29 fixedly attaches the first housing plate 18 to an external structure such as a seat bottom or other vehicle structure.

The second housing plate 20 similarly includes an elongate aperture 28 having a first end 30 and a second end 32 and is positioned relative to the first housing plate 18 such that aperture 22 is coaxially aligned with aperture 28. The second housing plate 20 also includes an attachment aperture 34 for fixedly attaching the second housing plate 20 to an external structure such as a seat bottom or other vehicle structure.

The torsion bar 14 is slidably received in apertures 22, 28 and includes a retainer 36 at each end to prevent removal of the torsion bar 14 from the apertures 22, 28. The torsion bar 14 extends from the first housing plate 18 to the second housing plate 20 and passes through a recliner mechanism 38. The torsion bar 14 is fixedly attached to the recliner mechanism 38 at an aperture 42 formed in a bracket 33 associated with the recliner mechanism 38. The torsion bar 14 is movable generally from the first end 24, 30 to the second end 26, 32 of each aperture 22, 28 and is formed from a material that allows the torsion bar 14 to yield when subjected to a predetermined force. The recliner mechanism is preferably of the type disclosed in assignee's commonly-owned U.S. patent application Ser. No. 11/197,740, filed Aug. 3, 2004.

As best shown in FIGS. 1, 3 and 4, the coil spring 16 includes a first arm 44, a second arm 46, and a coiled body 48. The first arm 44 is disposed generally at the center of the coiled body 48 and is received by the slot 31 of the spring post 27. The second arm 46 extends from the coiled body 48 and engages the torsion bar 14 to thereby bias the torsion bar 14 into engagement with the first end 24, 30 of each aperture 22, 28. A sufficient force must be applied to the torsion bar 14 to overcome the bias imparted thereon by the coil spring 16 to allow movement of the torsion bar 14 from the first end 24, 30 to the second end 26, 32 of each aperture 22, 28, as will be discussed further below.

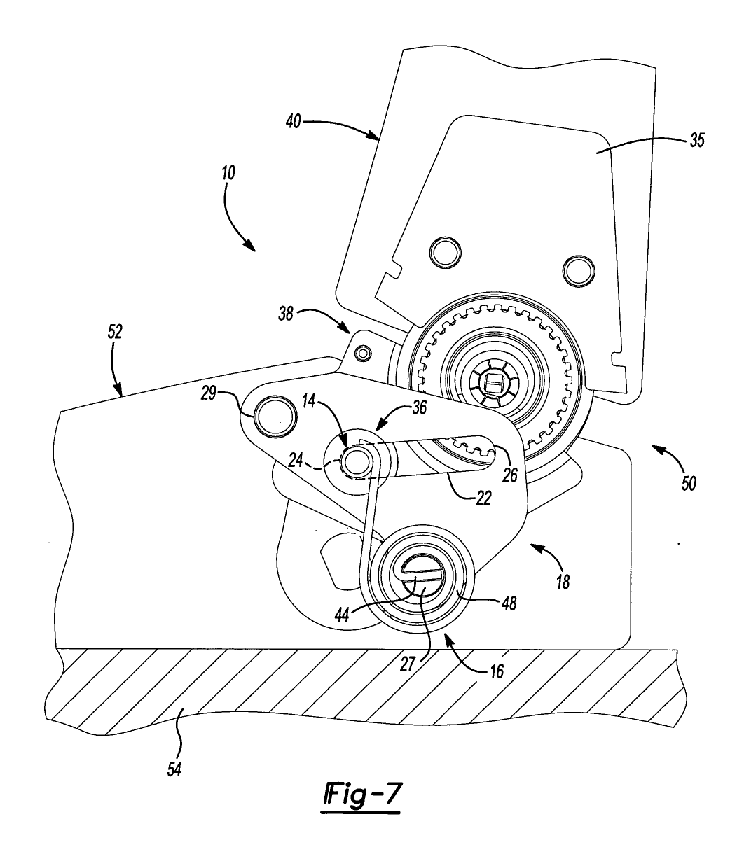

With reference to the FIGS. 7-9, the energy absorption system 10 is shown incorporated into a seat assembly 50. The seat assembly 50 includes a seatback 40 pivotally connected to a seat bottom 52 by the recliner mechanism 38. The recliner mechanism 38 allows selective angular positioning of the seatback 40 relative to the seat bottom 52. As shown in FIGS. 1-3, the recliner mechanism 38 may include a rod 56 that extends to a second recliner mechanism located at an opposite side of the seat assembly 50. The rod 56 allows the second recliner mechanism to be adjusted in response to adjustment of recliner mechanism 38.

The energy absorption system 10 is fixedly attached to the seatback 40 by a bracket 35 associated with the recliner mechanism 38 and to the seat bottom 52 by the second housing plate 20. Specifically, the torsion bar 14 is fixedly attached to the seatback 40 such that the torsion bar 14 is fixed for movement with the seatback 40 due to interaction between the torsion bar 14 and bracket 33. The housing 12 is essentially held stationary due to engagement between the seat bottom 52 and vehicle structure 54. However, the torsion bar 14 is permitted to move relative to the housing 12 and seat bottom 52 generally within each aperture 22, 28 in response to slidable movement of the seatback 40 relative to the seat bottom 52.

During normal use of the seat assembly 50, the seatback 40 is permitted to selectively rotate relative to the seat bottom 52 through actuation of the recliner mechanism 38. However, once the seatback 40 is positioned in a desired angular relationship relative to the seat bottom 52, the recliner mechanism 38 fixes the position of the seatback 40 and prevents further rotation of the seatback 40 until the recliner mechanism 38 is actuated once again. Therefore, when the seat assembly 50 is in a use position, the recliner mechanism 38 prevents rotation of the seatback 40 relative to the seat bottom 52.

If a sufficient force is applied to the seatback 40 by a vehicle occupant during a vehicle impact event, the seatback 40 transmits the force into the vehicle structure via the energy absorption system 10. When a predetermined force is applied to the seatback 40, the recliner mechanism 38, seatback 40, and torsion bar 14 move away from the first end 24, 30 of each aperture 22, 28 and against the bias of the coil spring 16. The torsion bar 14 continues rearward movement along each aperture 22, 28 until engaging the second end 26, 32 of each aperture 22, 28. Movement of the recliner mechanism 38, seatback 40, and torsion bar 14 against the bias of coil spring 16 absorbs energy associated with movement of the seatback 40 relative to the seat bottom 52.

At this point, the torsion bar 14 is engaged with the second end 26, 32 of each aperture 22, 28. If the force associated with the impact event is still applied to the seatback 40, and/or exceeds a predetermined threshold level, the torsion bar 14 yields to allow the seatback 40 to rotate relative to the seat bottom 52. Deformation of the torsion bar 14 permits rotation of the seatback 40 relative to the seat bottom 52 even though the recliner mechanism 38 is locked. Rotation of the seatback 40 is permitted due to deformation of the torsion bar 14, but is restricted to a rearward rotation of about 40 degrees to ensure that the occupant is properly supported. Deformation of the torsion bar 14 absorbs energy associated with movement of the seatback 40 relative to the seat bottom 52.

Rearward rotation of the seatback 40 is restricted generally to about 40 degrees through engagement of the seatback 40 with stops (not shown) fixedly attached to one or more of the housing 12, seat bottom 52, or the vehicle structure. Specifically, upon a 40 degrees rearward rotation of the seatback 40 relative to the seat bottom 52, the seatback 40 engages at least one stop (i.e., a pivot, post, etc.) fixedly attached to one of the housing 12, seat bottom 52, or the vehicle structure, to prevent further rotation and maintain the total rearward rotation of the seatback 40 at about 40 degrees. While the stop is generally referred to as fixedly attached to one or more of the housing 12, seat bottom 52, or the vehicle structure, it should be understood that the seatback 40 could also be shaped so as to engage at least one of the spring post 27 and/or the attachment post 29 to restrict the rearward rotation of the seatback 40 to about 40 degrees when the torsion bar 14 yields.

The energy absorption system 10 absorbs energy associated with the impact event and dissipates the energy to the vehicle structure to direct the energy away from the vehicle occupant. Movement of the torsion bar 14 against the bias of coil spring 16 serves to slow down the rearward movement of the seatback 40 relative to the seat bottom 52 and in so doing absorbs energy. Engagement between the torsion bar 14 and the second end 26, 32 of the aperture 22, 28 allows the housing 12 to transmit energy associated with the impact event to the vehicle structure via housing 12 and allows the vehicle structure to absorb energy associated with yielding of the torsion bar 14.

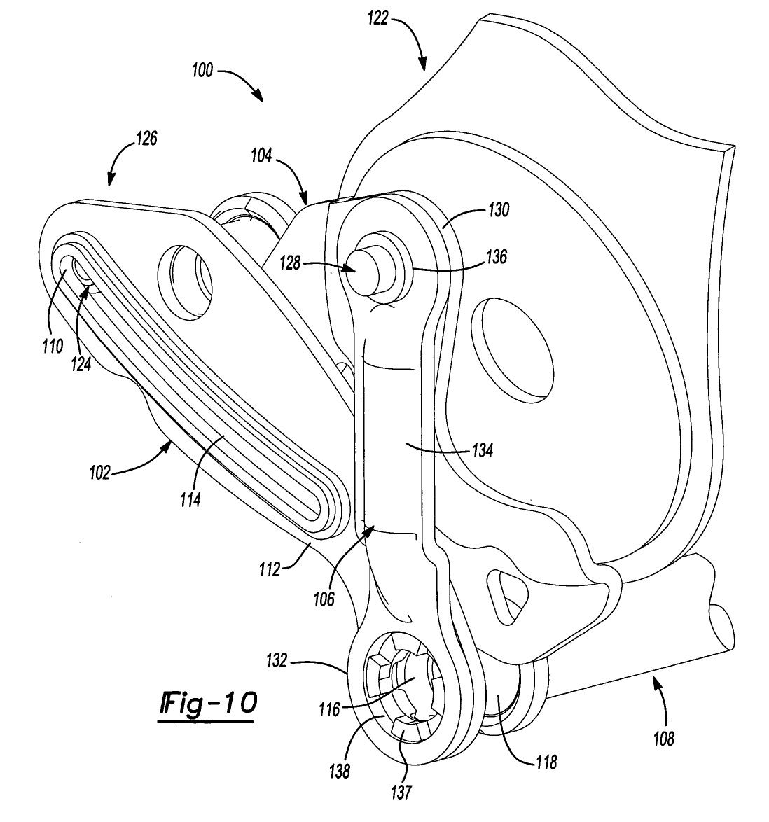

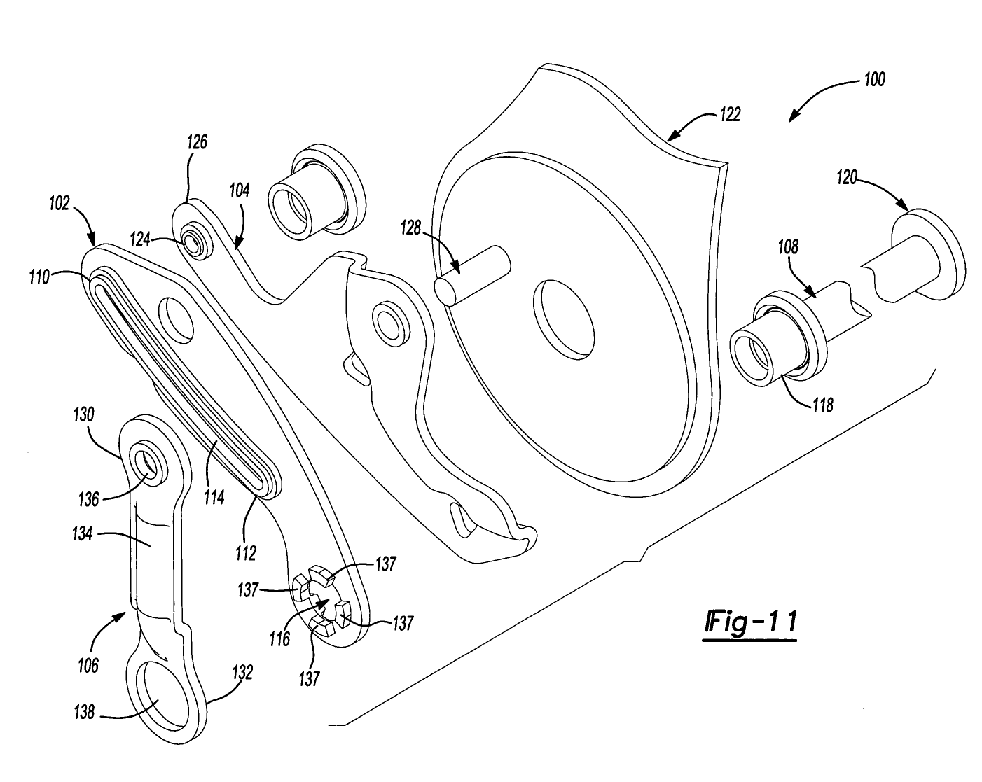

With reference to FIGS. 10-15, another variation of an energy absorption system 100 generally includes a guide bracket 102, a recliner bracket 104, a link 106, and a torsion bar 108.

The guide bracket 102 is fixed to an external structure such as a seat bottom or other vehicle structure and includes an elongate aperture 114 having a first end 110 and a second end 112. The guide bracket 102 also includes an aperture 116 for fixedly attaching the guide bracket 102 to a first end 118 of the torsion bar 108. The aperture 116 may include keys 137 to allow the torsion bar 108 to be easily fixed to the guide bracket 102.

Referring to FIGS. 10 and 12-15, the recliner bracket 104 is shown fixedly attached to a recliner plate 122. While the recliner bracket 104 is shown as a separate bracket, it should be understood that the recliner bracket 104 and the recliner plate 122 may be formed as one piece. The recliner bracket 104 includes a pin 124 extending generally from a distal end 126 that is slidably received within the elongate aperture 114 of the guide bracket 102. The recliner bracket 104 also includes a post 128 extending therefrom that rotatably supports the link 106.

The link 106 includes a first end portion 130, a second end portion 132, and a body portion 134 disposed therebetween. The first end portion 130 includes a first aperture 136 rotatably supported by the post 128 extending from the recliner bracket 104. The second end portion 132 includes a second aperture 138 fixedly attached to the first end 118 of the torsion bar 108. The second aperture 138 may be keyed to facilitate fixedly attaching the link 106 to the torsion bar 108.

The torsion bar 108 may be fixedly attached to the guide bracket 102 and fixedly attached to the link 106 at the first end 118, providing a rotational resistance therebetween. Such attachments may be accomplished via keyed slots in the link 106 and guide bracket 102. Specifically, the aperture 116 of the guide bracket 102 and the second aperture 138 of the link 106 may include keys 137. At its second end 120, the torsion bar 108 is fixedly attached to the seat bottom 52 or other vehicle structure.

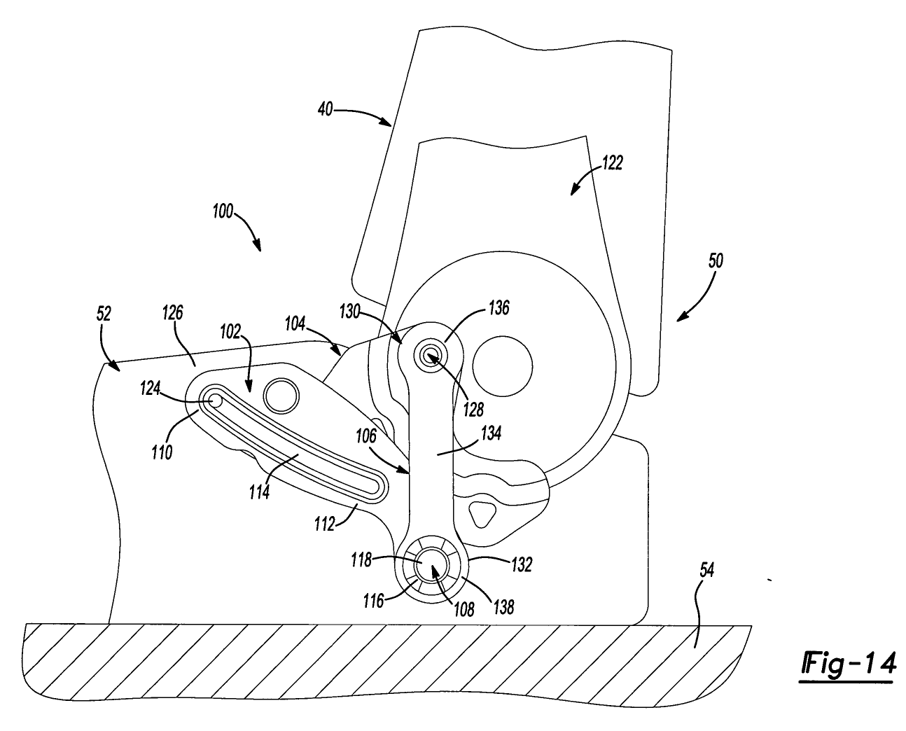

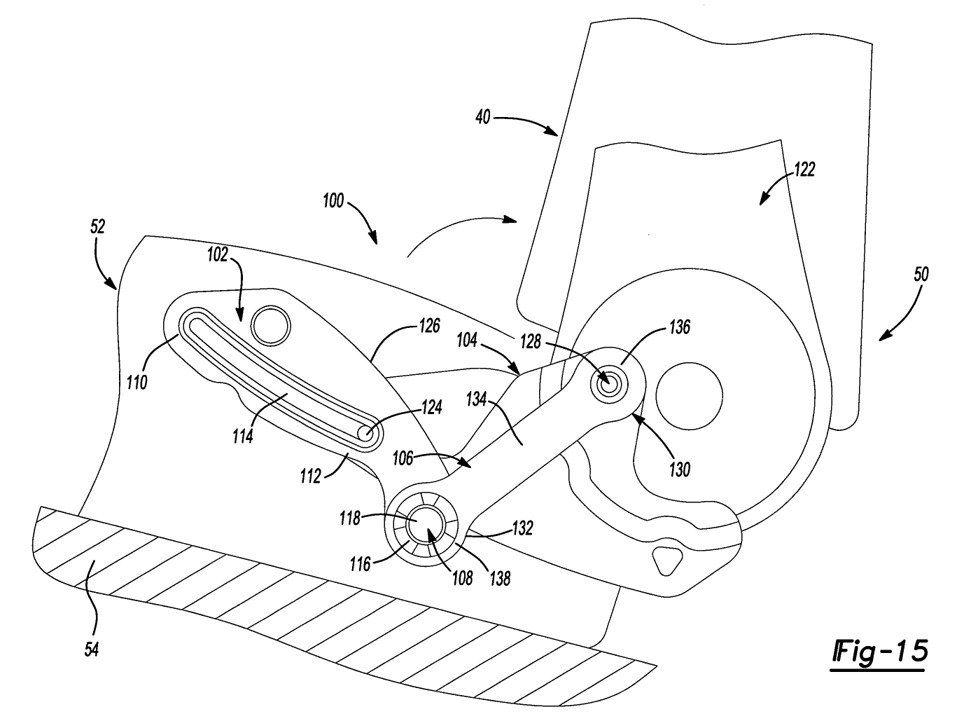

The energy absorption system 100 may be fixedly attached to the seat bottom 52 and the seatback 40 of the seat assembly 50, as described above with reference to FIGS. 1-9. With reference to FIGS. 14-15, the energy absorption system 100 is shown incorporated into the seat assembly 50. As previously discussed, the seatback 40 may be pivotally connected to the seat bottom 52 by a recliner mechanism 38 having the recliner plate 122 rotatable with the seatback 40.

The recliner mechanism 38 prevents rotation of the seatback 40 relative to the seat bottom 52 when in a locked state. Thus, the recliner mechanism 38 restricts movement of the recliner bracket 104 and the recliner plate 122 to a rearward position.

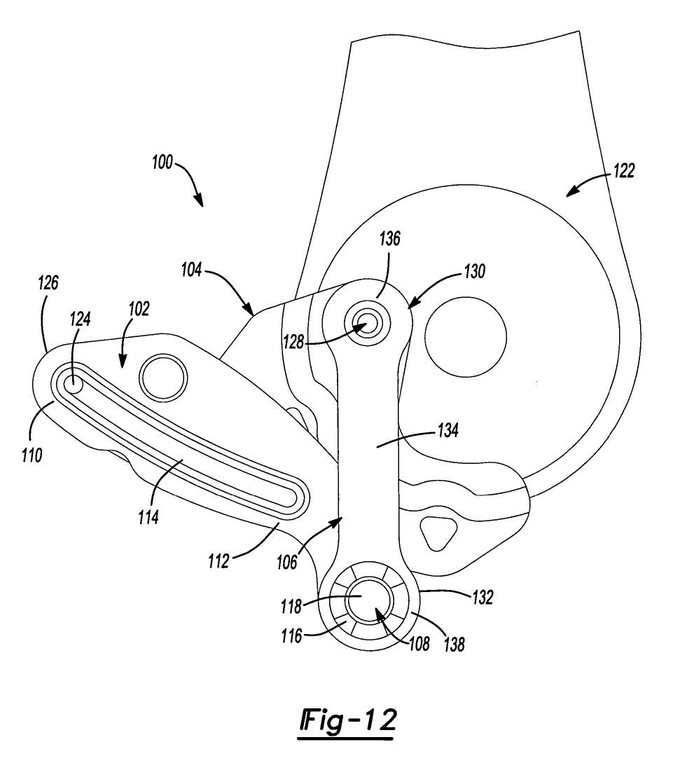

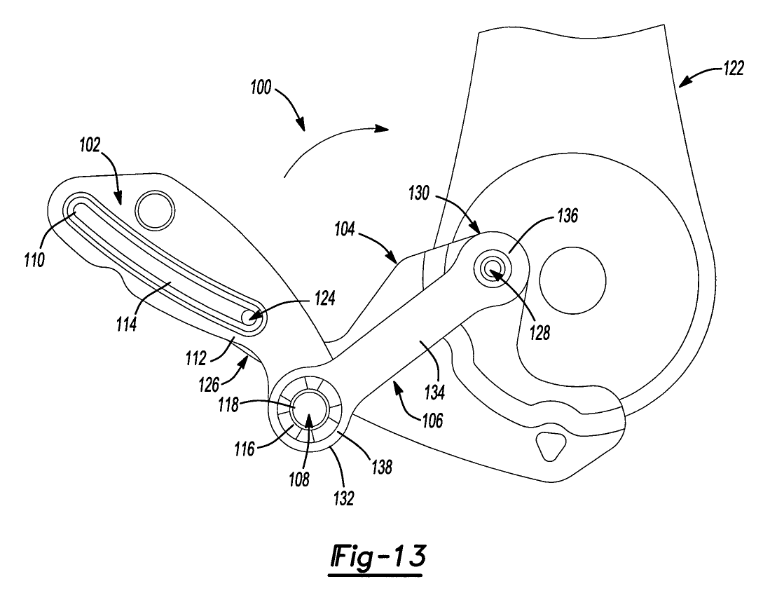

If a sufficient force is applied to the seatback 40, such as in a vehicle impact event, the seatback 40 transmits the force into the vehicle structure 54. Specifically, when a predetermined force is initially applied to the seatback 40, the link 106 rotates about the torsion bar 108 in a clockwise direction, relative to the view shown in FIGS. 13 and 15. As the link 106 rotates, the seatback 40 travels in a rearward and downward direction due to interaction between the pin 124 and the elongate aperture 114 located in the guide bracket 102 (i.e., moving from the first end 110 to the second end 112 of the elongate aperture 114). Travel of the seatback 40 is limited by a contact between the pin 124 extending from the recliner bracket 104 and the second end 112 of the elongate aperture 114 in the guide bracket 102. This contact generally limits the rotation of the link 106 to approximately 65 degrees in the clockwise direction (as shown in FIGS. 12-15) to ensure that the occupant is properly supported.

The link 106 is biased against rotation by the resistive force of the torsion bar 108, which acts against the rotational motion of the link 106. Therefore, when the link 106 rotates the torsion bar 108, the torsion bar 108 is deformed and absorbs a portion of the force being exerted upon the seatback 40. In other words, as a predetermined force is exerted upon the seatback 40, the link 106 rotates against the resistive force exerted on the link 106 by the torsion bar 108. As the link 106 acts against the resistive force of the torsion bar 108, the torsion bar 108 yields and absorbs a portion of the force being exerted on the seatback 40. In this manner, the energy absorption system 100 directs energy away from the occupant and into the vehicle seat assembly 50 and associated vehicle structure 54.

The above description is merely exemplary in nature and, thus, variations are intended to be within the scope of the teachings. Such variations are not to be regarded as a departure from the spirit and scope of the teachings.

What is claimed is:

1. An energy absorption system for a seat assembly having a seatback rotatably supported by a seat bottom, the energy absorption system comprising:
a first housing plate including a first elongate aperture formed therein defining a first end and a second end;
a second housing plate including a second elongate aperture formed therein defining a first end and a second end and coaxially aligned with said first elongate aperture;
a torsion bar slidably received within said first elongate aperture and said second elongate aperture and fixed for movement with the vehicle seatback;
a biasing member biasing said torsion bar toward said first ends of said elongate apertures;
wherein said torsion bar is configured to overcome said biasing member and move from said first ends of said first and second elongate apertures to said second ends of said first and second elongate apertures when a first predetermined force is applied to the seatback; and
wherein said torsion bar is configured to yield upon reaching said second ends of said elongate apertures when a second predetermined force is applied to the seatback.

2. The energy absorption system of claim 1, wherein said first predetermined force is equivalent to said second predetermined force.

3. The energy absorption system of claim 1, wherein said second predetermined force is greater than said first predetermined force.

4. The energy absorption system of claim 1, wherein said second predetermined force is less than said first predetermined force.

5. The energy absorption system of claim 1, wherein said first and second housing plates are fixedly attached to said seat bottom.

6. The energy absorption system of claim 1, wherein said biasing member is a coil spring.

7. The energy absorption system of claim 1, wherein said biasing member includes a coiled body and an outwardly extending arm.

8. The energy absorption system of claim 7, wherein said outwardly-extending arm engages said torsion bar to bias said torsion bar into engagement with said first end of said first and second apertures.

9. The energy absorption system of claim 1, wherein said biasing member is fixedly attached to one of said first and second housing plates.

10. The energy absorption system of claim 1, wherein said torsion bar includes a retainer at each end to prevent removal of said torsion bar from said elongate apertures.

11. The energy absorption system of claim 1, wherein said torsion bar is fixedly attached to the seatback.

12. The energy absorption system of claim 1, wherein the seatback is rotatably supported relative to the seat bottom by a recliner mechanism.

13. The energy absorption system of claim 1, further comprising at least one stop to limit rotation of the seatback beyond a predetermined angle.

14. An energy absorption system for a seat assembly having a seatback rotatably supported by a seat bottom, the energy absorption system comprising:
a first housing plate including a first elongate aperture formed therein defining a first end and a second end;
a second housing plate including a second elongate aperture formed therein defining a first end and a second end coaxially aligned with said first elongate aperture;
a torsion bar slidably received within said first elongate aperture and said second elongate aperture and fixed for movement with the vehicle seatback;
a biasing member biasing said torsion bar toward said first ends of said elongate apertures;
wherein the seatback is configured to move linearly along a first axis when a first predetermined force is applied to the seatback; and
wherein the seatback is configured to move rotationally when a second predetermined force is applied to the seatback.

15. The energy absorption system of claim 14, wherein said first predetermined force is equivalent to said second predetermined force.

16. The energy absorption system of claim 14, wherein said second predetermined force is greater than said first predetermined force.

17. The energy absorption system of claim 14, wherein said second predetermined force is less than said first predetermined force.

18. The energy absorption system of claim 14, wherein said first and second housing plates are fixedly attached to said seat bottom.

19. The energy absorption system of claim 14, wherein said biasing member is a coil spring.

20. The energy absorption system of claim 14, wherein said biasing member includes a coiled body and an outwardly extending arm.

21. The energy absorption system of claim 20, wherein said outwardly-extending arm engages said torsion bar to bias said torsion bar into engagement with said first end of each aperture.

22. The energy absorption system of claim 14, wherein said biasing member is fixedly attached to one of said first and second housing plates.

23. The energy absorption system of claim 14, wherein said torsion bar includes a retainer at each end to prevent removal of said torsion bar from said apertures.

24. The energy absorption system of claim 14, wherein said torsion bar is fixedly attached to the seatback.

25. The energy absorption system of claim 14, wherein the seatback is rotatably supported relative to the seat bottom by a recliner mechanism.

26. The energy absorption system of claim 14, further comprising at least one stop to limit rotation of the seatback beyond a predetermined angle.

27. An energy absorption system for a seat assembly having a seatback rotatably supported by a seat bottom comprising:
a guide bracket fixed to said seat bottom and including an elongate aperture;
a recliner bracket fixed for movement with the vehicle seatback and including a first projection extending therefrom and disposed within said elongate aperture of said guide bracket to guide movement of the seatback relative to the seat bottom;
a link having a first end and a second end, said first end rotatably attached to said recliner bracket; and
a torsion bar fixedly attached to said second end of said link at a first end and attached to said guide bracket at a second end, said torsion bar deformed when a predetermined force is applied to the seatback due to movement of said recliner bracket and rotation of said link.

28. The energy absorption system of claim 27, wherein said guide bracket is fixedly attached to said torsion bar through a keyed slot arranged in said aperture.

29. The energy absorption system of claim 27, wherein a length of said elongate aperture limits rotation of said link to about 65 degrees.

30. The energy absorption system of claim 27, further comprising a recliner mechanism disposed between the seatback and seat bottom.
